(19) United States
(12) Patent Application Publication
(10) Pub. No.: US 2023/0065951 A1
(43) Pub. Date: Mar. 2, 2023

(54) TRANSMITTING PARAMETERS TO A COMMUNICATIONS DEVICE RESPONSIVE TO DIGITIZATION OF A MACHINE-READABLE CODE FROM A TANGIBLE OBJECT

(71) Applicant: Payfone, Inc., d/b/a Prove, New York, NY (US)

(72) Inventor: Dimitre Mirolub Boyukliev, Dobbs Ferry, NY (US)

(21) Appl. No.: 17/410,918

(22) Filed: Aug. 24, 2021

(51) Int. Cl. G06Q 20/34; G06K 19/06; H04W 8/18; H04W 12/06

(52) U.S. Cl. CPC G06Q 20/342; G06K 19/06037; H04W 8/183; H04W 12/06

(57) ABSTRACT

Briefly, example methods, apparatuses, and/or articles of manufacture may be implemented, in whole or in part, using one or more computing devices to obtain, via a communications network, one or more signals representing an indication of value encoded utilizing a machine-readable code available at a tangible object. The communications network may additionally obtain one or more signals representing an identifier of a communications device. The communications device may be authenticated based, at least in part, on the one or more signals representing the identifier. One or more signals that represent a complement of subscriber-specific parameters may be transmitted in response to the authenticating.

### BACKGROUND

### 1. Field

The present disclosure relates generally to use of a communications device to digitize parameters obtained from a machine-readable code, which may be printed on a tangible object (e.g., a gift card, etc.), to bring about display of certain parameters utilizing a user interface of the device without a need for significant interaction between the individual and the communications device.

### 2. Information

The World Wide Web or simply the Web, as provided by the Internet, has grown rapidly in recent years at least partially in response to the relative ease by which a wide variety of types of transactions can be enabled and/or performed via the Internet. As a consequence of widely available Internet connections, including connections to the Internet facilitated by cellular communication services, a mobile subscriber may shop and/or browse for virtually any product and/or service utilizing a communications device. Further, it may be appreciated that an ability to shop and/or browse via a communications device may involve only a portion or aspect of an overall mobile communications device-facilitated shopping ecosphere.

In some instances, shopping in the mobile device-facilitated ecosphere may include the use of a gift card or a prepaid stored-value money card, which may be issued by a retailer or a bank, to be used as an alternative to cash for purchases within a particular store or other type of establishment. However, a physical gift card, for example, may be accompanied by the risk of being lost prior to an opportunity to obtain goods and/or services in accordance with the value of the gift card. Additionally, a physical gift card may constitute an object that must be kept within a person's wallet, purse, or backpack, so as to be available when an opportunity to redeem the gift card presents itself. It may be appreciated that in response to a gift card not being at a person's immediate disposal may lead to a person missing an opportunity to use a gift card, for example. As such, a physical gift card may represent yet another artifact that can be easily forgotten, misplaced, lost, stolen, and/or damaged, for example.

In addition to the above-identified drawbacks of physical gift cards, it may be problematic for a gift card user to be mindful or to keep track of various amounts of indicated value associated with multiple gift cards in the user's possession. In some instances, a user may utilize an ink pen to write a gift card's remaining balance directly on a surface of the gift card. Accordingly, developing measures to enhance a gift card's security as well as developing techniques to increase ease-of-use of a gift card continues to be an active area of investigation.

### SUMMARY

One general aspect of claimed subject matter relates to a method that includes obtaining, via a communications network, one or more signals representing an indication of value encoded utilizing a machine-readable code available at a tangible object, the one or more signals representing the indication of value to be provided by a communications device. The method also includes obtaining, via a communications network, one or more signals representing an identifier of a communications device. The method also includes authenticating the communications device based, at least in part, on the one or more signals representing the identifier. The method further includes transmitting, via the communications network, one or more signals to represent a complement of subscriber-specific parameters in response to the authenticating.

In particular embodiments, the machine-readable code includes one or more quick response (QR) codes. In particular embodiments, the machine-readable code includes one or more characters that are human-readable. In particular embodiments, the complement of subscriber-specific parameters correspond to parameters for completing an electronic document to obtain an account with a merchant. In particular embodiments, the machine-readable code is encoded on a viewable surface of a gift card and includes one or more unique number combinations and/or an identifier exclusive to the gift card, a remaining balance of the gift card, and/or an indicator as to whether the gift card has been activated. In particular embodiments, authenticating the communications device includes receiving, via the communications network, one or more parameters accessed from a subscriber information module (SIM) of the communications device. In particular embodiments, the communications network includes a mobile cellular communications network. In particular embodiments, the method may additionally include receiving one or more parameters entered utilizing a user interface of the communications device responsive to a prompt displayed via the user interface of the communications device. In particular embodiments, the one or more parameters entered utilizing the user interface of the communications device correspond to at least a portion of a unique identifier corresponding to an owner of the communications device, at least a portion of a physical address corresponding to the owner of the communications device, a parameter known only or exclusively to the owner of the communications device, a biometric parameter of the owner of the communications device, and/or any combination thereof. In particular embodiments, authenticating the communications device includes determining a number of porting requests have been received over a duration with respect to the communications device, a tenure of the communications device, whether a SIM of the communications device has been removed and/or replaced over the duration, whether a one-time password of a communications device subscriber account has been requested, or any combination thereof.

Another general aspect of claimed subject matter relates to a processor coupled to at least one memory device to obtain, from a network coupled to a communications device, one or more signals representing an indication of value encoded utilizing a machine-readable code at a tangible object, the one or more signals representing the indication of value to be provided by a communications device. The processor coupled to the at least one memory are also to obtain, from the network, one or more signals representing an identifier of the communications device. The processor coupled to the at least one memory are also to authenticate the communications device based, at least in part, on the one or more signals representing the identifier. The processor coupled to the at least one memory is also to transmit, via the network, one or more signals to represent a complement of subscriber-specific parameters in response to the authenticating.

In particular embodiments, the processor coupled to the at least one memory are also to authenticate the communications device by way of determining a number of porting requests that have been received over a duration with respect to the communications device, and/or to determine a tenure of the communications device, and/or to determine whether a SIM of the communications device has been removed and/or replaced over the duration, and/or to determine whether a one-time password of a communications device subscriber account has been requested, and/or to determine any combination thereof. In particular embodiments, the processor coupled to the at least one memory device are further to receive one or more parameters entered utilizing a user interface of the communications device responsive to a prompt displayed via the user interface of the communications device. In particular embodiments, the one or more parameters entered utilizing the user interface of the communications device correspond to at least a portion of a unique identifier corresponding to an owner of the communications device, at least a portion of a physical address corresponding to the owner of the communications device, a parameter known only or exclusively to the owner of the communications device, a biometric parameter of the owner of the communications device, or any combination thereof. In particular embodiments, the tangible object includes a gift card and the machine-readable code includes a QR code. In particular embodiments, the processor coupled to the at least one memory device to authenticate the communications device are additionally to receive, via the network, one or more parameters accessed from a SIM of the communications device.

Another general aspect of claimed subject matter relates to an article including a non-transitory storage medium having instructions stored thereon executable by a special-purpose computing platform to obtain, from a network coupled to a communications device, one or more signals representing an indication of value encoded utilizing a machine-readable code at a tangible object, the one or more signals representing the indication of value to be provided by a communications device. The executable instructions are also to obtain, from the network, one or more signals representing an identifier of the communications device. The executable instructions are also to authenticate the communications device based, at least in part, on the one or more signals representing the identifier. The executable instructions are also to transmit, via the network, one or more signals to represent a complement of subscriber-specific parameters in response to the authenticating.

In particular embodiments, the tangible object includes a gift card. In particular embodiments, the machine-readable code includes a QR code. In particular embodiments, the identifier of the communications device is to be obtained from a SIM of the communications device. In particular embodiments, authenticating the communications device includes determining a number of porting requests that have been received over a duration with respect to the communications device, and/or to determine a tenure of the communications device, and/or to determine whether a SIM of the communications device has been removed and/or replaced over the duration, and/or to determine whether a one-time password of a communications device subscriber account has been requested, and/or to determine any combination thereof.

### BRIEF DESCRIPTION OF THE DRAWINGS

Claimed subject matter is particularly pointed out and distinctly claimed in the concluding portion of the specification. However, both as to organization and/or method of operation, features, and/or advantages thereof, it may best be understood by reference to the following detailed description if read with the accompanying drawings in which:

FIG. 1 is a diagram of a telecommunications infrastructure, according to various embodiments.

FIG. 2 shows a subscriber interacting with a cellular communications network to obtain a complement of subscriber-specific parameters in response to determining parameter values encoded via a machine-readable code available on a tangible object, according to an embodiment.

FIG. 3 shows a signal flow diagram in a method of transmitting a complement of user parameters to a communications device, according to an embodiment.

FIG. 4 shows a communications device displaying a user interface to accept a complement of user parameters responsive to determining parameter values encoded via a machine-readable code available on a tangible object, according to an embodiment.

FIG. 5 shows a process of transmitting a complement of user parameters to a communications device, according to an embodiment.

FIG. 6 is a diagram showing a computing environment, according to an embodiment.

FIG. 7 shows a flowchart for a process of transmitting a complement of user parameters to a communications device in response to determining parameter values encoded via a machine-readable code available on a tangible object, according to an embodiment.

Reference is made in the following detailed description to the accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others, one or more aspects, properties, etc. may be omitted, such as for ease of discussion, or the like. Further, it is to be understood that other embodiments may be utilized. Furthermore, structural and/or other changes may be made without departing from claimed subject matter. References throughout this specification to “claimed subject matter” refer to subject matter intended to be covered by one or more claims, or any portion thereof, and are not necessarily intended to refer to a complete claim set, to a particular combination of claim sets (e.g., method claims, apparatus claims, etc.), or to a particular claim.

### DETAILED DESCRIPTION

References throughout this specification to one implementation, an implementation, one embodiment, an embodiment, and/or the like means that a particular feature, structure, characteristic, and/or the like described in relation to a particular implementation and/or embodiment is included in at least one implementation and/or embodiment of claimed subject matter. Thus, appearances of such phrases, for example, in various places throughout this specification, are not necessarily intended to refer to the same implementation and/or embodiment or to any one particular implementation and/or embodiment. Furthermore, it is to be understood that particular features, structures, characteristics, and/or the like described, are capable of being combined in various ways in one or more implementations and/or embodiments and, therefore, are within intended claim scope. In general, of course, for the specification of a patent application, these and other issues have a potential to vary in a particular context of usage. In other words, throughout the disclosure, particular context of description and/or usage provides guidance regarding reasonable inferences to be drawn; however, likewise, the term “in this context” in general without further qualification refers at least to the context of the present patent application.

In an environment in which electronic communication devices, mobile cellular telephones, voice over Internet protocol (VoIP) communications devices, etc., have become ubiquitous, a communications device user may wish to perform one or more electronic or digital transactions (e.g., complete an application for credit, engage in an electronic financial transaction, purchase a product or service, apply for a loan, complete one or more forms of an application for healthcare while visiting a health provider's office, or completing many other types of electronic documents) utilizing such electronic communications devices. To facilitate such transactions, a subscriber co-located with a personal electronic communications device may establish an identity, such as may be established in connection with an electronic communications device subscriber account, with a cellular or mobile communications device services carrier, a VoIP services provider, or other type of telecommunications carrier. Establishment of an electronic communications device subscriber account, utilizing, for example, a subscriber account identifier, may permit the identity of an individual attempting to engage in an electronic or digital transaction to be authenticated, authorized, and/or verified. In some instances, given the nature of electronic or digital transactions, such as in an environment in which electronic or digital transactions may be initiated via a communications network at any time and at any location, it may be useful to be able to verify and/or authenticate the user relatively quickly, such as in a real-time fashion or with reduced delay.

As a general matter, verification of a transacting party, such as via use of a communications device, may be desirable in response to an institution or organization (e.g., third party, etc.) seeking to determine the identity of a transacting party (e.g., a mobile subscriber). Verification of a transacting party may involve establishing a correspondence and/or association of the transacting party with a persistent mobile subscriber account identifier, as demonstrated below through illustrative examples. In this context, a correspondence, association, and/or similar terms refer to a persistent, continuing and objectively verifiable relationship between a transacting party in possession of, for example, a particular mobile communications device. Thus, a unique subscriber account identifier may be employed to signify and/or identify a particular transacting party. In this context, the term “mobile communications device identity” and/or similar terms refer to an identity that relies on a mobile communications device account relationship (also referred to as a correspondence and/or association) of a user as a source of authenticating, authorizing, and/or verifying a transacting party and is capable of being verified by another (e.g., a third-party auditing, authorizing and/or verifying entity). The term “mobile subscriber device account” and/or similar terms in this context refer to a mobile communication services provider account. The terms “mobile communications device services provider,” “mobile communications device carrier,” “mobile network operator” may be used interchangeably. Furthermore, in this context, the term “mobile device services carrier,” “telecommunication services carrier,” “service carrier,” or simply “carrier” may refer to an entity of a telecommunications infrastructure that provides wired and/or wireless communication services to the general public for a consideration, such as a monthly subscription fee.

Thus, a carrier (e.g., a telecommunication services carrier) may comprise a communication services provider and/or mobile network operator. However, there are examples of carriers that provide services to communications devices that do not correspond to mobile communications device services providers and/or mobile network operators. Such instances may include wireline services providers (for example, providers of services operating within the public switched telephone network or PSTN), which include wireline services for rotary dial telephones and/or telephones utilizing, for example, dual tone multi-frequency (DTMF) signaling. Accordingly, the terms “services carrier” or simply “carrier” may be used in place of a mobile communications device services provider and/or wireline telephone services provider without a loss in meaning and/or understanding. Further the term “communications device” is intended to encompass mobile communications devices, wireline communications devices, VoIP communications devices, and so forth. In a given situation, particular context of usage should indicate if a term is being used in its most general sense or in a narrow sense, such as referring to a mobile communications device services provider, wireline services provider, mobile paging services provider, and/or mobile network operator, for example.

It is noted that while a correspondence or association between a transacting party and a communications device need not be long-term, such correspondence or association between a transacting party and a communications device should imply some amount of persistence to be of use in this context. Other aspects of verifying and/or authenticating a subscriber are described in greater detail later. For example, in an embodiment, verifying and/or authenticating a transacting party may relate to a mobile account and/or a mobile subscriber. Further, a mobile subscriber account is one example of a type of subscriber account, especially in a networked electronic commerce environment, although claimed subject matter is not intended to be limited to online accounts or to mobile accounts. Rather, the term “account” or “subscriber account” in this context refers to a formal business arrangement between an entity, person, or other type of transacting party, and a provider of the account in order to accomplish a business purpose, for example. The term “account” is intended to be broadly interpreted as an arrangement that provides certain privileges. In this context, such privileges may involve access to credit, so as to permit the purchase of goods or services, access to privileged content, such as premium entertainment content (e.g., premium sports, cinema, or other entertainment content). Also in this context, the term “privileged content” is intended to be interpreted broadly and to encompass any type of content available exclusively to certain individuals and/or certain entities in response to supplying certain credentials. Also in this context the term “parameters” refers to a numerical or other measurable factor capable of defining a system and/or sets conditions for operation of a system. Thus, for example, a set of parameters may include data or information stored via a non-transitory memory that form or define, at least in part, an electronic representation of the state of a subscriber, such as a mobile subscriber.

Likewise, an account may comprise attributes associated with or corresponding to the account. In this context, the term “subscriber account identifier” or simply “identifier” refers to a unique descriptor or feature associated with the account that defines certain aspects of the account. For example, as nonlimiting illustrations, with respect to a mobile device user, a subscriber account identifier may include a mobile telephone number, a mobile subscriber unique alias, an international mobile subscriber identifier, Integrated Circuit Card Identifier, a mobile services and/or other type of identifier (e.g., a unique identifier) employed in connection with the particular mobile network operator or the mobile communication services provider. Mobile communications networks may include those compatible or compliant with a Global System for Mobile Communications (GSM) telecommunications network, for example. Other examples of mobile subscriber account identifiers may include an International Mobile Equipment Identifier, a Mobile Station International Subscriber Directory Number or any other identifier including a mobile billing account number/identifier.

As discussed herein, a subscriber co-located with a communications device may apply for an account, such as a credit account, for example, or any other type of account that imparts or confers particular privileges to the subscriber. In many instances, to obtain such privileges, a subscriber may be required to complete an application, such as an application for an account, an application for credit, and application for an increase in credit, or any other type of formal request involving the subscriber supplying subscriber-specific information, data, parameters, and so forth. However, as previously alluded to, completing an application for such privileges (e.g., a line of credit) may involve the subscriber interacting with a user interface of a communications device having a small-form keyboard, keypad, etc. Such data entry, utilizing small-form keyboards/keypads, may easily introduce errors which may, in turn, bring about the need for a user to re-enter personal data so that the credit application, for example, can be completed.

Thus, in particular embodiments of claimed subject matter, a complement of subscriber-specific user parameters may be conveyed to a communications device, so as to facilitate the relatively effortless completion of various user interface activities. In particular embodiments, a complement of subscriber-specific user parameters may be conveyed to the communications device in response to a subscriber digitizing, for example, parameters of certain tangible objects, such as gift cards or other types of stored-value cards (e.g., electronic benefits transfer cards, etc.), which may or may not be reloadable. Thus, in some instances, scanning, reading, or otherwise acquiring values of parameters stored utilizing a tangible object, such as a gift card, may function as a point of entry to initiate a relationship between a subscriber of a particular communications device and, for example, a merchant that issued the gift card. In some embodiments, following the opening of an account with a particular merchant, which may be in response to a subscriber scanning, reading, or otherwise acquiring values of parameters stored via the gift card, for example, a value, such as a monetary value, linked to the gift card may be immediately applied to the subscriber's newly-opened account. In a particular embodiment, digitized parameters of a machine-readable code, such as a QR code printed on a surface of a gift card, along with one or more identifiers relating to a communications device in the subscriber's possession, may be transmitted to a server operated by the merchant issuing the gift card. A computing resource (e.g., a “client”) or other computing entity, operating under the control of the merchant, may transmit the one or more identifiers relating to the communications device to an identity verifier, who may authenticate the subscriber at the merchant's request based, at least in part, on the one or more transmitted identifiers.

Responsive to such authentication, an identity verifier may transmit subscriber-specific parameters to the client computing resource, or other computing entity operating under the control of the merchant, along with a trust score or other indicator of the trustworthiness of the subscriber. Subscriber-specific parameters may comprise a subscriber's full name, physical address, employer, education level, and a host of other parameters, virtually without limitation. In accordance with the merchant's business rules and/or business logic, and based, at least in part, on subscriber-specific parameters, the merchant may determine that the subscriber is sufficiently credit worthy, and may thus offer to extend credit, for example, to the subscriber. The merchant may then transmit a complement of subscriber-specific parameters to a communications device associated with the subscriber, such as in the form of a pre-populated credit application. Responsive to receipt of subscriber-specific parameters, which may populate the fields of a credit application, the subscriber may simply “approve” the credit application. In particular embodiments, by selecting to “approve” the pre-filled credit application, the communications device may transmit the completed credit application to the server operating under the control of the merchant. Following receipt of the completed credit application, the merchant may instantiate the newly-created user account in the merchant's account holder system and apply the value indicated on the gift card (or other type of stored-value card) to the user account.

Accordingly, in particular embodiments, a subscriber in possession of a communications device may be capable of opening an account with a merchant associated with a gift card, or other tangible object having an encoded indication of value, in the subscriber's possession. Opening an account with the merchant may be initiated by the subscriber operating the communications device, such as to obtain an image of a QR code, or to otherwise obtain an indication of the value stored via the gift card (e.g., via a barcode, magnetic stripe, etc.). Thus, a subscriber may virtually effortlessly open an account with the merchant issuing the gift card and obtain a beginning balance corresponding to the stored value indicated by, for example, the gift card (or other type of tangible object having a machine-readable indication of value). Additionally, at least in particular embodiments, a merchant may establish accounts corresponding to new and credit worthy account holders whose initial experience with the merchant relates to obtaining a credit corresponding to a value stored via the gift card. Consequently, a subscriber and a merchant (and potentially others) may benefit from the newly formed relationship between the subscriber and the merchant. Further, in view of a subscriber's first-time experience with the merchant relating to obtaining goods and/or services from the merchant, the subscriber may be likely to return to the merchant to engage in future transactions.

It may also be appreciated that obtaining a complement of subscriber-specific parameters, which may be utilized to populate fields of an online credit application displayed via a subscriber's communications device, may be advantageous for additional reasons. For example, in typical instances, a user may complete a credit application via manually entering parameters such as full name, address, Social Security number, date-of-birth, past/present addresses, past/present employers, etc. It may be appreciated that engaging in a few simple operations, such as by way of a communications device (e.g., a mobile communications device) so that a user interface of the communications device may be populated or pre-filled with a complement of user-specific parameters. In particular embodiments, such pre-filling/pre-population of fields of a credit application may replace manual and error-prone entry of parameters, thus bringing about a potentially error-free and streamlined process of completing a credit application. Further, such pre-filling/pre-population of fields of credit application may represent a secure process in which subscriber-specific parameters are extracted from a centralized, trusted database, which may thus prevent or preclude an unscrupulous individual from fraudulently opening a credit account, for example, utilizing another person's name, address, Social Security number, etc.

Some example methods, apparatuses, and/or articles of manufacture are disclosed herein that may facilitate and/or support one or more operations and/or techniques that relate to transmitting a complement of user parameters to a communications device responsive to obtaining signals representing an indication of value encoded utilizing a machine-readable code. Such techniques may be implemented in connection with a processor-equipped cellular mobile communications device (which may be referred to herein as a “mobile communications device”) communicating with one or more computing devices via the one or more communication networks (such as cellular communications networks) utilizing one or more communications protocols (e.g., network protocols, etc.) discussed herein. In this context, the term “article” refers to an article of manufacture as well as a data or memory structure having instructions stored thereon. The communications device may be utilized to verify and/or authenticate a transacting party, such as a party interacting with a communications device to determine an indication of value that has been encoded utilizing a machine-readable code on or within a tangible object (e.g., a gift card, etc.). Responsive to receipt of a complement of subscriber-specific parameters, the communications device may be utilized to complete an online application for credit, wherein an indication of value encoded via the machine-readable code is automatically (e.g., without user input) applied toward the credit account.

Although the discussion that follows relates to any type of account, as a non-limiting illustration, merchant accounts established via a subscriber's communications device (e.g., mobile communications device) may be used for illustration. However, it is understood, of course, that claimed subject matter is intended to not be limited to examples provided primarily for purposes of illustration, since such examples may be oversimplified for purposes of comprehension, for example.

The following provides a few illustrative examples of accounts, which a subscriber may establish responsive to acquiring an indication of value encoded utilizing machine-readable code available at a tangible object (e.g., a gift card). An account may correspond to a merchant account, such as an account associated with a department store, a housewares retailer, an apparel retailer, an airline, or any other type of merchant that may benefit from permitting customers, or potential customers, to establish an account. In other embodiments, a tangible object may correspond to a generic stored-value card, such as a gift card comprising indication of stored value, wherein such value may be redeemed at any number of merchants or other establishments, such as those that accept payment via one or more credit card types. In such instances, an indication of stored value may be extracted from the tangible object and stored in a digital wallet or other electronic counterpart to a physical wallet.

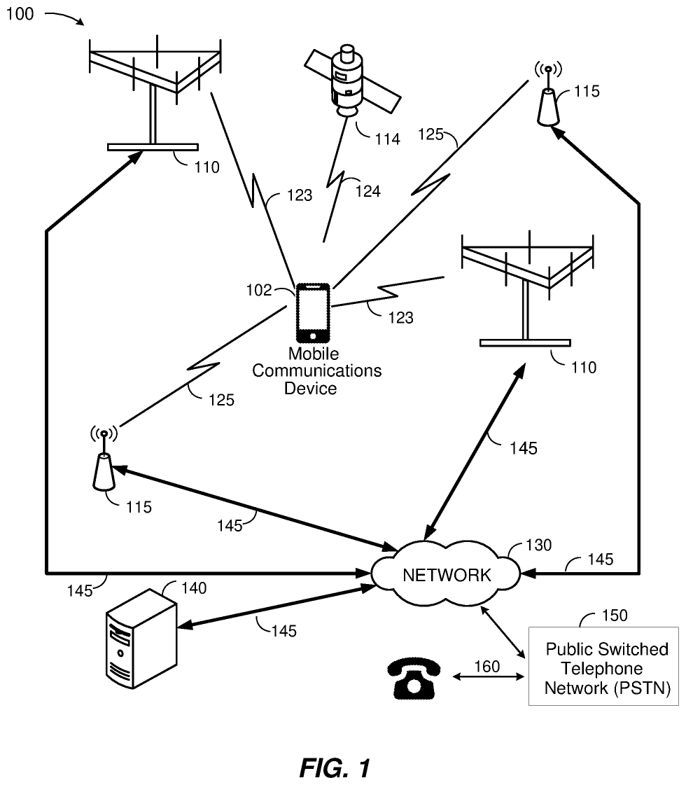

In FIG. 1 (embodiment 100) communications device 102 may transmit radio signals to, and receive radio signals from, a wireless communications network. In an example, communications device 102 may communicate with a cellular communications network by transmitting wireless signals to, and/or receiving wireless signals from, a cellular transceiver 110, which may comprise a wireless base transceiver subsystem (BTS), a Node B or an evolved NodeB (eNodeB), over wireless communication link 123. Similarly, communications device 102 may transmit wireless signals to, and/or receive wireless signals from, local transceiver 115 over wireless communication link 125. A local transceiver 115 may comprise an access point (AP), femtocell, Home Base Station, small cell base station, Home Node B (HNB) or Home eNodeB (HeNB) and may provide access to a wireless local area network (WLAN, e.g., IEEE 802.11 network), a wireless personal area network (WPAN, e.g., Bluetooth® network) or a cellular network (e.g. an LTE network or other wireless wide area network, such as those discussed herein). Of course, it should be understood that these are merely examples of networks that may communicate with a communications over a wireless link, and claimed subject matter is not limited in this respect. In particular embodiments, cellular transceiver 110, local transceiver 115, satellite 114, and PSTN 150 represent touchpoints, which permit communications device 102 to interact with network 130.

Examples of network technologies that may support wireless communication link 123 are GSM, Code Division Multiple Access (CDMA), Wideband CDMA (WCDMA), Long Term Evolution LTE), High Rate Packet Data (HRPD). GSM, WCDMA and LTE are technologies defined by 3GPP. CDMA and HRPD are technologies defined by the 3^{rd} Generation Partnership Project 2 (3GPP2). WCDMA is also part of the Universal Mobile Telecommunications System (UMTS) and may be supported by an HNB. Cellular transceivers 110 may comprise deployments of equipment providing subscriber access to a wireless telecommunication network for a service (e.g., under a service contract). In the embodiment of FIG. 1, a cellular transceiver 110 may perform functions of a cellular base station in servicing subscriber devices within a cell determined based, at least in part, on a range at which the cellular transceiver 110 is capable of providing access service. Examples of radio technologies that may support wireless communication link 125 are IEEE 802.11, BT and LTE.

In a particular implementation, cellular transceiver 110 and local transceiver 115 may communicate with server 140, such as by way of network 130 via communication links 145. Here, network 130 may comprise any combination of wired or wireless links and may include cellular transceiver 110 and/or local transceiver 115 and/or server 140. In a particular implementation, network 130 may comprise Internet Protocol (IP) or other infrastructure capable of facilitating communication between communications device 102 at a call source and server 140 through local transceiver 115 or cellular transceiver 110. In an embodiment, network 130 may also facilitate communication between communications device 102, server 140 and a PSTN 150, for example through communications link 160. In another implementation, network 130 may comprise a cellular communication network infrastructure such as, for example, a base station controller or packet based or circuit based switching center (not shown) to facilitate mobile cellular communication with communications device 102. In a particular implementation, network 130 may comprise local area network (LAN) elements such as WiFi APs, routers and bridges and may, in such an instance, comprise links to gateway elements that provide access to wide area networks such as the Internet. In other implementations, network 130 may comprise a LAN and may or may not involve access to a wide area network but may not provide any such access (if supported) to communications device 102. In some implementations, network 130 may comprise multiple networks (e.g., one or more wireless networks and/or the Internet). In one implementation, network 130 may include one or more serving gateways or Packet Data Network gateways. In addition, one or more of server 140 may comprise an E-SMLC, a Secure User Plane Location (SUPL) Location Platform (SLP), a SUPL Location Center (SLC), a SUPL Positioning Center (SPC), a Position Determining Entity (PDE) and/or a gateway mobile location center (GMLC), each of which may connect to one or more location retrieval functions (LRFs) and/or mobility management entities (MMEs) of network 130.

In particular embodiments, communications between communications device 102 and cellular transmitter 110, satellite 114, local transceiver 115, and so forth may occur utilizing signals communicated across wireless communications channels. Accordingly, the term “signal” may refer to communications utilizing propagation of electromagnetic waves across wireless communications channels. Signals may be modulated to convey messages utilizing one or more techniques such as amplitude modulation, frequency modulation, binary phase shift keying (BPSK), quaternary phase shift keying (QPSK) along with numerous other modulation techniques, and claimed subject matter is not limited in this respect. Accordingly, as used herein, the term “messages” refers to parameters, such as binary signal states, which may be encoded in a signal using one or more of the above-identified modulation techniques.

In particular implementations, and as discussed below, communications device 102 may comprise circuitry and processing resources capable of obtaining location related measurements (e.g. for signals received from GPS or other Satellite Positioning System (SPS) satellites 114), cellular transceiver 110 or local transceiver 115 and possibly computing a position fix or estimated location of communications device 102 based on these location related measurements. In some implementations, location related measurements obtained by communications device 102 may be transferred to a location server such as an enhanced serving mobile location center (E-SMLC) or SUPL location platform (SLP) (e.g. which may comprise a server, such as server 140) after which the location server may estimate or determine an estimated location for communications device 102 based on the measurements. In the presently illustrated example, location related measurements obtained by communications device 102 may include measurements of signals (124) received from satellites belonging to an SPS or Global Navigation Satellite System (GNSS) such as GPS, GLONASS, Galileo or Beidou and/or may include measurements of signals (such as 123 and/or 125) received from terrestrial transmitters fixed at known locations (e.g., such as cellular transceiver 110).

Communications device 102 or a separate location server may obtain a location estimate for communications device 102 based on location related measurements using any one of several position methods such as, for example, GNSS, Assisted GNSS (A-GNSS), Advanced Forward Link Trilateration (AFLT), Observed Time Difference Of Arrival (OTDOA) or Enhanced Cell ID (E-CID) or combinations thereof. In some of these techniques (e.g. A-GNSS, AFLT and OTDOA), pseudoranges or timing differences may be measured at communications device 102 relative to three or more terrestrial transmitters fixed at known locations or relative to four or more satellites with accurately known orbital data, or combinations thereof, based at least in part, on pilots, positioning reference signals (PRS) or other positioning related signals transmitted by the transmitters or satellites and received at communications device 102. Here, server 140 may be capable of providing positioning assistance data to communications device 102 including, for example, information regarding signals to be measured (e.g., signal timing), locations and identities of terrestrial transmitters and/or signal, timing and orbital information for GNSS satellites to facilitate positioning techniques such as A-GNSS, AFLT, OTDOA and E-CID. For example, server 140 may comprise an almanac to indicate locations and identities of cellular transceivers and/or local transceivers in a particular region or regions such as a particular venue, and may provide information descriptive of signals transmitted by a cellular base station or AP such as transmission power and signal timing. In the case of E-CID, communications device 102 may obtain measurements of signal strengths for signals received from cellular transceiver 110 and/or local transceiver 115 and/or may obtain a round trip signal propagation time (RTT) between communications device 102 and a cellular transceiver 110 or local transceiver 115. A communications device 102 may use these measurements together with assistance data (e.g. terrestrial almanac data or GNSS satellite data such as GNSS Almanac and/or GNSS Ephemeris information) received from server 140 to determine a location estimate for communications device 102 or may transfer the measurements to server 140 to perform the same determination. A call from communications device 102 may be routed, based on the location of communications device 102, and connected to PSTN 150, for example, via wireless communication link 123 and communications link 160.

A communications device at a call source (e.g., mobile communications device 102 of FIG. 1) may be referred to by any name corresponding to a cellphone, smartphone, laptop, tablet, PDA, tracking device or some other portable or movable device. Typically, though not necessarily, a communications device may support wireless communication such as using GSM, WCDMA, LTE, CDMA, HRPD, WiFi, BT, WiMax, etc. A communications device may also support wireless communication using a wireless LAN (WLAN), DSL or packet cable for example. A communications device may comprise a single entity or may comprise multiple entities such as in a personal area network where a user may employ audio, video and/or data I/O devices and/or body sensors and a separate wireline or wireless modem. An estimate of a location of a communications device (e.g., communications device 102) may be referred to as a location, location estimate, location fix, position, position estimate or position fix, and may be geographic, thus providing location coordinates for the communications device (e.g., latitude and longitude) which may or may not include an altitude component (e.g., height above sea level, height above or depth below ground level, floor level or basement level).

The architecture of the cellular communications network described in relation to FIG. 1 may comprise a generic architecture that is capable of accommodating a variety of outdoor and indoor location solutions including the standard SUPL user plane location solution defined by the Open Mobile Alliance (OMA) and standard control plane location solutions defined by 3GPP and 3GPP2. For example, server 140 may function as (i) a SUPL location platform to support the SUPL location solution, (ii) an E-SMLC to support the 3GPP control plane location solution with LTE access on wireless communication link 123 or 125, or (iii) a Standalone Serving Mobile Location Center (SAS) to support the 3GPP Control Plane Location solution for UMTS.

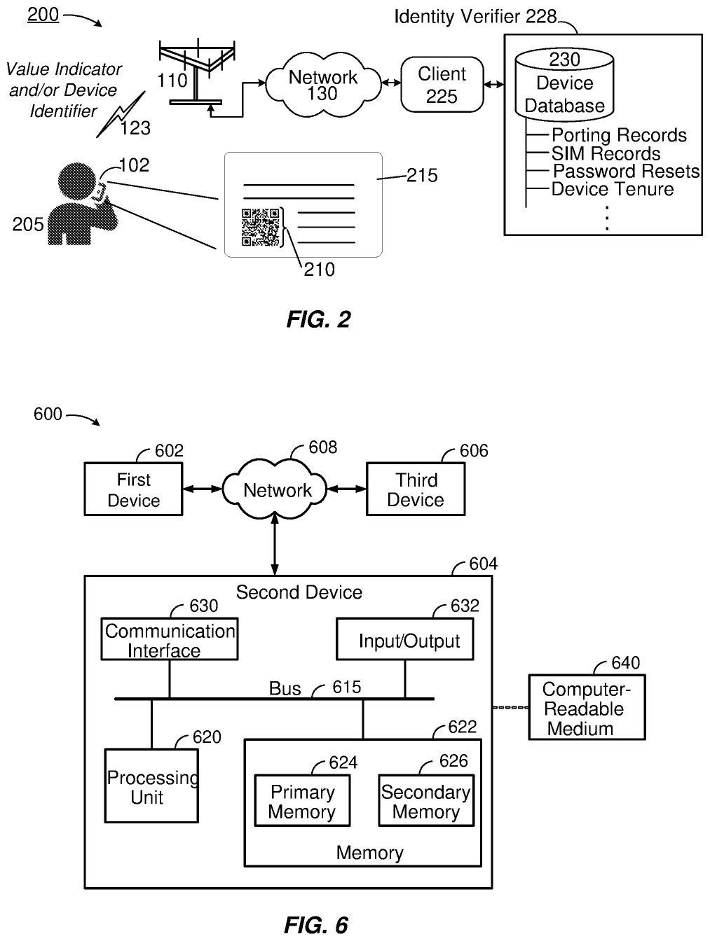

In view of the communications infrastructure shown and described in reference to FIG. 1, more particular embodiments directed to transmitting or conveying parameters to a communications device in response to digitization of a machine-readable code from a tangible object are discussed hereinbelow. Hence, FIG. 2 (embodiment 200) shows a subscriber interacting with a cellular communications network to obtain a complement of subscriber-specific parameters in response to determining parameter values encoded via a machine-readable code available on a tangible object, according to an embodiment. In the embodiment of FIG. 2, subscriber 205 may be located at any point within communications range of cellular transceiver 110. In the embodiment of FIG. 2, subscriber 205 may be presently located in a department store, just as an example, within view of machine-readable code 210. Machine-readable code 210 may be printed or displayed, for example, on a physical gift card or on any other physical or electronic medium that may function as a physical gift card. In other embodiments, machine-readable code 210 may be printed, for example, on a generic stored-value card, such as a card that stores a pre-paid value that is redeemable at any location that accepts, for example, credit cards. In particular embodiments, subscriber 205 may redeem a tangible object, such as a gift card, for a consideration other than a monetary amount.

Machine-readable code 210 may comprise a two-dimensional bar-code; however, in other embodiments, machine-readable code 210 may comprise any other type of machine-readable entity, such as a one-dimensional bar-code, or any other type of machine-recognizable or computer-recognizable pattern, such as a QR code. In other embodiments, machine-readable code 210 may function in a radio frequency (RF) domain, in which case interrogating a machine-readable code 210 may bring about transmission of a radiofrequency signal in response to a query signal. In other instances, machine-readable code 210 may operate as an inductive circuit element, in which a magnetic field coupled to the inductive circuit element undergoes a series of discernible, readable transitions in response to changes in current conduction through the inductive circuit element of tangible object 215.

In the embodiment of FIG. 2, subscriber 205 may situate communications device 102 so as to permit viewing, image capture, or to otherwise obtain signals representing parameter values corresponding to an indication of value encoded via machine-readable code 210, which has been printed on, inscribed on, or is otherwise accessible from tangible object 215. In particular embodiments, machine-readable code 210 may comprise a QR code, an image of which may be captured utilizing a camera of communications device 102. It should be noted that although tangible object 215 resembles a gift card in FIG. 2, claimed subject matter is not limited to tangible objects resembling or having a substantially rectangular form factor of a gift card. Rather, claimed subject matter is intended to embrace tangible objects of all shapes and sizes, for example. In the embodiment of FIG. 2, responsive to communications device 102 acquiring signals, such as optical signals, representing an indication of value encoded on tangible object 215, subscriber 205 may initiate an application for a credit account. Communications device 102 may execute a computer process in response to capturing or viewing an image of machine-readable code 210 (e.g., a QR code), which may direct the communications device to a location indicated by way of a uniform resource locator (URL) displayed via a browser operating on communications device 102. In some instances, the URL may correspond to a client computing device operating under the control of a merchant, such as a retailer, a department store, a restaurateur, or the like, offering gift cards for purchase and transfer.

As indicated in FIG. 2, an indication of value encoded via machine-readable code 210, along with appropriate identifying parameters and/or indicators, may be transmitted via communications device 102 for reception by cellular transceiver 110. Cellular transceiver 110 may communicate, via network 130, to client 225. In particular embodiments, client 225 may represent a merchant or other issuing entity/agency of a tangible object 215 (e.g., a gift card). Thus, client 225 may comprise a server that operates under the direction and/or control of a major retailer, a department store chain, a restaurateur, or any other business that may issue, or at least direct the issuance of, tangible object 215.

In addition to transmitting an indication of value encoded via tangible object 215, as well as additional parameters and/or indicators, communications device 102 may additionally transmit one or more identifiers specific to communications device 102. For example, a browser program operating on a processor of communications device 102 may instruct the device to access a memory storage element, such as a SIM inserted into a receptacle of communications device 102, to obtain an identifier of the communications device. In particular embodiments, an identifier of a communications device may comprise a subscriber account identifier (e.g., a telephone number), an International Mobile Subscriber Identifier, an International Mobile Electronic Identifier, or a Mobile Station International Subscriber Directory Number, or any combination thereof. An identifier of a communications device 102 may be transmitted to cellular transceiver 110 along with an indication of value obtained from a machine-readable code printed, for example, on the surface of tangible object 215.

Thus, in the embodiment of FIG. 2, an indication of value, parameters and/or identifiers, read or extracted from machine-readable code 210 as well as one or more identifiers of communications device 102 may be conveyed through one or more communication links to client 225. Responsive to receipt of a value indication and other parameters and/or indicators encoded utilizing machine-readable code 210, and one or more identifiers of communications device 102, client 225 may initiate a process to establish a credit account for subscriber 205. A process to establish a credit account for subscriber 205 may involve client 225 communicating with identity verifier 228, which may, in turn, access device database 230. In the embodiment of FIG. 2, device database 230 may include records of various deterministic events with respect to communications device 102. Records of deterministic events may comprise records of a number porting of communications device 102, records related to removal/replacement of a SIM device 102, instances of password resets of device 102, records of the tenure of device 102 (e.g., duration that subscriber 205 has been associated with device 102), and so forth. Device database 230 may include records that relate to other aspects of the behavior of subscriber 205 with respect to communications device 102, and claimed subject matter is not limited in this respect.

In response to receipt of an identifier from communications device 102, via cellular transceiver 110, network 130, and client 225, identity verifier 228 may transmit a complement of subscriber-specific parameters to client 225. In particular embodiments, identity verifier 228 may transmit a subscriber name, physical address (e.g., street address, city, town, municipality, ZIP Code, etc.) along with other subscriber-specific parameters, which may include Social Security number, current employment, salary parameters, marital status, and a number of other subscriber-specific parameters. In some embodiments, identity verifier 228 may additionally transmit past physical addresses, current/past employer parameters, and a host of subscriber-specific parameters, and claimed subject matter is not limited in this respect.

Additionally, identity verifier 228 may transmit a trust score or other measure of the trustworthiness of subscriber 205. In particular embodiments, a measure of the trustworthiness of subscriber 205 may be expressed in the form of a composite score, such as a single number between 0 and 1000, for example, or may be expressed utilizing a range of numbers, such as between 200 and 400, 400 and 600, 600 and 800, and so forth. In other instances, a trust score or trustworthiness measure may be expressed in the form of a reference to a threshold number, such as >600, >700, >800, etc. It should be noted that claimed subject matter is intended to embrace virtually any approach toward expressing a trust score or other measure of trustworthiness.

Responsive to a trust score or other measure of the trustworthiness of subscriber 205, client 225 may instantiate an account corresponding to subscriber 205. In particular embodiments, as part of a process to instantiate an account corresponding to subscriber 205, client 225 may transmit a request for one or more additional subscriber-specific parameters. For example, an identifying parameter may correspond to a Social Security number, or a portion thereof (e.g., last four digits) for entry the by way of a user interface of communications device 102. Client 225 may request any other identifying parameter(s), and claimed subject matter is not limited in this respect. Responsive to receipt of such a request, subscriber 205 may enter the one or more additional identifying parameters (e.g., last four digits of Social Security number), which may operate to provide verification and/or authentication of subscriber 205. The one or more additional identifying parameters may be transmitted, via communications link 123 and cellular transceiver 110, to client 225. Responsive to receipt of the one or more additional identifying parameters, client 225 may determine that subscriber 205 is the authentic (e.g., verified) owner of communications device 102, and/or that communications 102 is co-located with subscriber 205. Client 225 may make additional determinations based on the one or more additional identifying parameters, and claimed subject matter is not limited in this respect.

Client 225 may retrieve or otherwise access an indication of value, for example, from machine-readable code 210. Client 225 may then deposit a monetary amount corresponding to the indication of value read or extracted from machine-readable code 210. Alternatively, or in addition to, client 225 may upload an indication of a remaining balance of the gift card, an indication as to whether the gift card has been activated (e.g., purchased).

It may be appreciated that in the embodiment of FIG. 2, in response to one or more parameters being read or extracted from a machine-readable code inscribed or printed on a surface of a tangible object (e.g., a gift card), client 225 may permit a subscriber to establish a credit account with a merchant issuing, for example, a gift card. Further, responsive to one or more identifiers accessed from a communications device utilized by subscriber 205, client 225 may be assured that subscriber 205 meets minimum trustworthy standards according to business logic and/or business rules set forth by client 225. Following the establishment of a credit account with a merchant, client 225 may deposit an amount corresponding to the value indicated via the machine-readable code into the newly-established account. In at least one embodiment, to establish a credit account, and to load a value encoded in the machine-readable code of a gift card, subscriber 205 may simply select to “submit” the pre-filled credit application. Accordingly, in such a scenario, an application, such as a credit application, can be completed and preloaded with an indicated value of the gift card following a few simple interactions with communications device 102, such as capturing and transmitting an image of a machine-readable code, entering a portion of a Social Security number, and depressing a “submit” selector.

In particular embodiments, pre-fill of a credit application responsive to determining parameter values encoded via a machine-readable code on a tangible object (e.g., a gift card) may be determined utilizing flexible, client-defined rules and/or guidelines. For example, eligibility for pre-fill of a credit application and preload of a value indication into a newly created credit account may be determined utilizing (but not limited to) criteria such as data attributes, which, for example, may include name/address, Social Security number, date-of-birth, household ID (e.g., last name of perhaps multiple subscribers living at a common physical address, etc.) Eligibility for credit account application pre-fill and loading of a value indication into a credit account may also be dependent upon reputational scoring, which may correspond to the reputation of communications device 102 and/or subscriber 205. For example, a trustworthiness score or other measure of trustworthiness may be utilized in computing reputational scoring. Eligibility for pre-fill of a form may also be dependent upon demographic attributes of a subscriber, such as the subscriber's chronological age, ZIP Code of residence, taxable income, and so forth. Eligibility for pre-fill of a form may also be dependent upon industry-specific attributes of a subscriber. For example, in an e-commerce environment, determining eligibility for pre-fill of a credit application may involve, perhaps exclusively, parameters such as a subscriber name, address, phone number (or other type of subscriber account identifier), whereas in a regulated industry (e.g., a financial services or telecommunication services carriers) entry of parameters such as name, address, phone number (or other type of subscriber account identifier) Social Security number, date of birth, etc. Such parameters may fulfill know your customer (KYC) regulatory requirements for new account origination. Eligibility for pre-fill of a form may also utilize industry-specific scoring or computed metrics, which may include a lifetime value (e.g., covering a period of one year, two years, three years, etc.) based upon past transactional and/or purchase history. Industry-specific scoring may include behavioral interaction such as repeat visits, community engagement, or client-derived reputation scores.

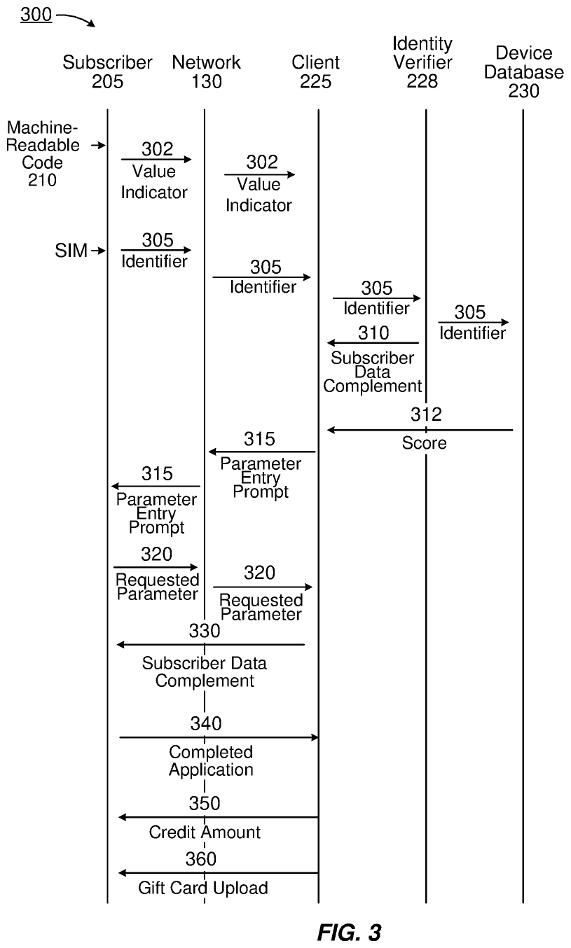

FIG. 3 shows a signal flow diagram in a method of transmitting a complement of user parameters to a communications device, according to an embodiment 300. The diagram of FIG. 3 begins with subscriber 205 interacting with a communications device, such as device 102 of FIG. 1, to obtain value indicated 302 encoded via a machine-readable code available on a tangible object utilizing, for example, a camera imager of device 102. As described with respect to FIG. 2, capture of machine-readable code 210, for example, may permit communications device 102 to connect with a client computing resource, such as client 225, operating under the control of a merchant (e.g., a department store, a housewares retailer, an apparel retailer, an airline retailer) to permit subscriber 205 to complete an application for credit. Responsive to a communications device obtaining machine-readable parameters, value indicator 302, encoded on a tangible object (e.g., gift card), value indicator 302 may be transmitted to network 130 via cellular transceiver 110. Value indicator 302 may be received at client 225, for short-term storage at a memory device of client 225, for example, while client 225 operates to determine if an account is to be established on behalf of subscriber 205.

In addition to parameter values encoded via a machine-readable code available via a tangible object, a communications device may additionally access identifier 305 from a SIM, for example, of communications device 102. Identifier 305 may be conveyed through cellular transceiver 110 and through network 130 for presentation to client 225. Client 225 may, in turn, pass identifier 305 to identity verifier 228. Responsive to receipt of identifier 305, identity verifier 228 may access device database 230, which may provide subscriber data complement 310 (e.g., name, current/past addresses, current/past employers, phone number, and so forth). Subscriber data complement 310 may additionally include a query other type of request for one or more additional identifying parameters for confirmation/verification by subscriber 205. Subscriber data complement 310 may be stored, at least temporarily, within a memory device at client 225.

In the embodiment of FIG. 3, a device database, such as device database 230 of FIG. 2, may additionally supply trustworthiness score 312 with respect to communications device 102. In particular embodiments, trustworthiness score 312 may be computed in response to determining events, which may occur with respect to communications device 102. Such events may correspond to a length of time that a subscriber 205 has been in possession of communications device 102 (e.g., device tenure), whether communications device 102 has been recently ported (e.g., involving a telephone number or other subscriber account identifier) from a first communication services carrier to a second communication services carrier, whether a one-time password has been utilized to reset account parameters accessed by communications device 102, as well as any number of additional online or off-line events involving device 102. A trustworthiness score may be computed utilizing a history of other deterministic events with respect to communications device 102, and claimed subject matter is not limited in this respect.

Client 225 may generate and transmit a request for one or more additional parameters from subscriber 205. Additional parameters may correspond to parameters perhaps known only or exclusively to subscriber 205, such as a portion of a Social Security number (e.g., the last four digits), a mother's maiden name, name of childhood friend, city of birth, or any other parameter, and claimed subject matter is not limited in this respect. A query for one or more additional parameters may form parameter entry prompt 315, which may be conveyed through network 130, through cellular transceiver 110, for delivery to cellular communications device 102. Responsive to receipt of parameter entry prompt 315, which may be displayed via a display of communications device 102, subscriber 205 may provide requested parameter 320. Requested parameter 320 may be conveyed through cellular transceiver 110 and through network 130 for receipt by client 225. Responsive to receipt of the requested data 320, client 225 may compare requested parameter 320 with one or more corresponding parameters to determine if a match exists. Responsive to detection of a match, client 225 may determine that subscriber 205 has been authenticated/verified. Accordingly, client 225 may transmit a subscriber data complement 330 to communications device 102 for review by subscriber 205. In addition, client 225 may retrieve value indicator 302 stored in a short-term memory accessible to client 225.

Responsive to receipt of the complement of subscriber data at communications device 102, device 102 may pre-fill (e.g., populate) fields of an application or other type of form, perhaps use in connection with obtaining credit by subscriber 205. Subscriber 205 may merely review and/or verify entries of a pre-filled form displayed via a display of communications device 102. Subscriber 205 may then elect to depress a “submit” selector, which may operate to convey completed credit application 340, for example, through network 130 to client 225. Upon receipt of a completed credit application, for example, client 225 may compute a credit amount and/or compute any other amount or parameter, and forward such amount to subscriber 205 for display on a display of communications device 102. Credit amount 350 may be computed based, at least in part, on score 312 computed by identity verifier 228 responsive to accessing device database 230. In particular embodiments, responsive to device database 230 indicating that communications device 102 can be considered to be relatively trustworthy, such as following a determination that fraudulent events have not occurred in connection with device 102, score 312 may comprise a relatively high number. In addition to client 225 computing credit amount 350, client 225 may upload, at 360, a gift card amount as a credit to the newly-established account corresponding to the value encoded via machine-readable code 210. Conversely, responsive to device database 230 indicating that communications device 102 can be considered relatively untrustworthy, such as following a determination that fraudulent events have occurred in connection with device 102, score 312 may comprise a relatively low number.

In particular embodiments, certain operations shown in FIG. 3 may not be performed. For example, in response to client 225 determining that subscriber 205 includes an individual or other entity that already holds a credit account with a particular merchant, for example, client 225 may simply upload, such as at 360, a gift card amount as a credit to the existing credit account. In other embodiments, such as those in which machine-readable code 210 indicates a generic stored value that does not pertain to or involve a specific merchant, value indicator 302 may simply be added to an electronic wallet stored utilizing communications device 102 and managed by subscriber 205.

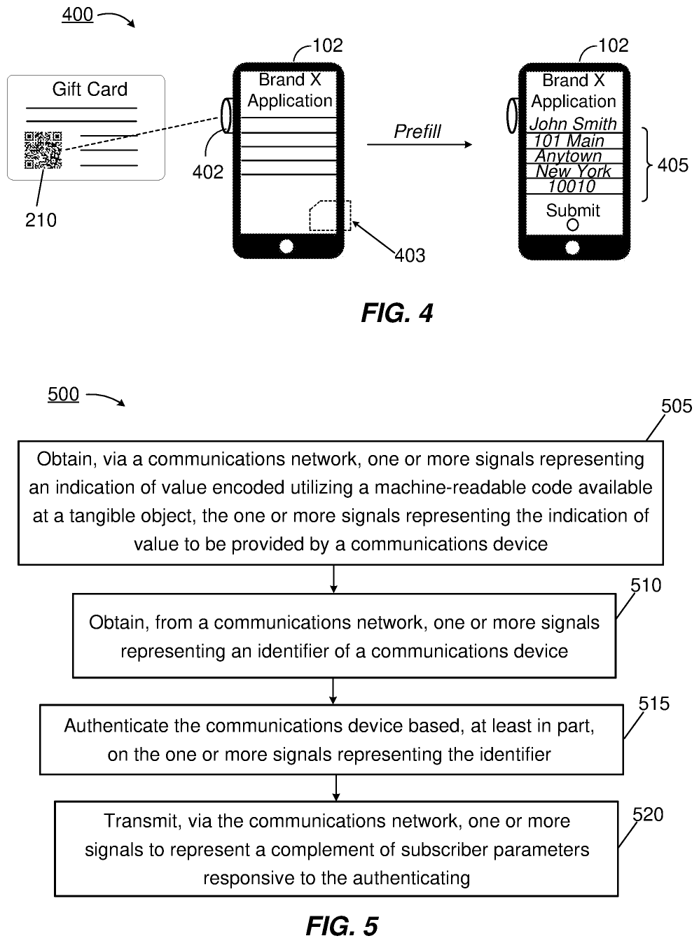

FIG. 4 shows a communications device displaying a user interface to accept a complement of user parameters responsive to determining parameter values encoded via a machine-readable code available on a tangible object, according to an embodiment 400. As shown at the left-hand side of FIG. 4, communications device 102 comprises image capture device 402, which may correspond to a camera, for example. In an embodiment, a subscriber, such as subscriber 205 of FIG. 2, may position machine-readable code 210 into the field of view of image capture device 402. Responsive to machine-readable code 210 being within view of image capture device 402, a process executing on a processor of communications device 102 may be directed to connect to client 225 (e.g., via a URL) for the purpose of transmitting parameters determined from a machine-readable code available on a tangible object. In alternative embodiments, communications device 102 may be directed to connect to client 225 (e.g., via a URL) for the purpose of adding an amount corresponding to a value encoded the machine-readable code to an existing credit account with a merchant.

In addition to transmitting parameters encoded via a machine-readable code available on a tangible object, communications device 102 may additionally transmit an identifier accessed, for example, from SIM 403, which may be inserted into a receptacle of communications device 102. In some embodiments, an identifier stored on SIM 403 may comprise a subscriber account identifier (e.g., a telephone number), International Mobile Subscriber Identifier, an International Mobile Electronic Identifier, or a Mobile Station International Subscriber Directory Number, or any combination thereof. The identifier, and parameter values encoded via the machine-readable code, may be conveyed through a cellular communications network, such as described with reference to FIG. 1, to a client (e.g., client 225 of FIG. 2), which may correspond to a computing resource under the direction and/or control of a merchant, for example, involved in forming credit accounts on behalf of subscribers. In turn, client 225 may contact an identity verification service (e.g., identity verifier 228 of FIG. 2), who may access a device database (e.g., device database 230) to obtain parameters specific to the subscriber 205 co-located with communications device 102. In some embodiments, device database 230 may also provide a trustworthiness score or other measure of trustworthiness, with respect to communications device 102, based, at least in part, on records of historical events involving communications device 102. Such records may include instances of reassignment (or porting) of subscriber account identifiers (e.g., telephone numbers) from a first communication services carrier to a second communication services carrier, tenure of device 102, instances of password resets with respect to device 102, removal or replacement of a SIM (e.g., SIM 403), along with other behavioral aspects with respect to device 102.

As shown at the right hand side of FIG. 4, in response to a client (e.g., client 225 of FIG. 2) determining a complement of subscriber-specific parameters corresponding to an identifier accessed from SIM 403, a blank application form, such as indicated in FIG. 4, may be pre-filled with subscriber-specific parameters. Such parameters may include subscriber's full name, past and/or present addresses, past and/or present employers, and other specific parameters. In particular embodiments, pre-filled application 405 may be displayed on a display of communications device 102 within seconds (e.g., 10 seconds, 20 seconds, 30 seconds, 60 seconds, 90 seconds, or more or less) of subscriber 205 capturing an image of machine-readable code 210. In particular embodiments, an intermediate operation, not explicitly indicated in FIG. 4, may involve subscriber 205 verifying one or more additional parameters, such as the last four digits of a Social Security number, for example, as an approach toward validating and/or verifying the identity of subscriber 205, prior to conveying the complement of subscriber-specific parameters indicated as pre-filled application 405.

In particular embodiments, responsive to submitting a pre-filled application for credit to a client under the control of, for example, a merchant, the client may establish a credit card account on behalf of the subscriber. In addition, the client may upload an indication of value encoded via a machine-readable code, such as machine-readable code 210.

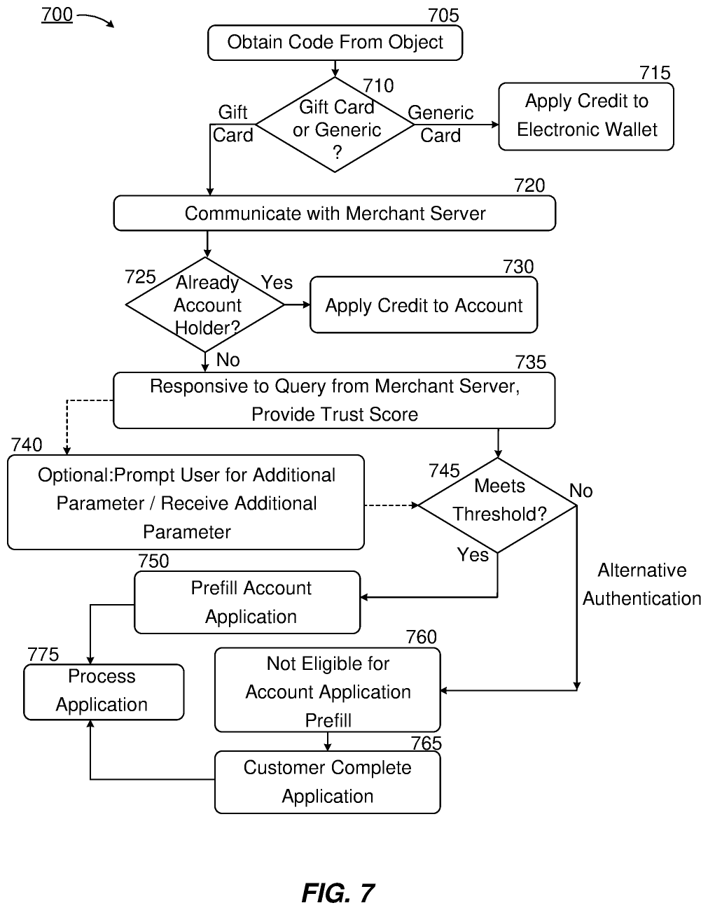

FIG. 5 shows a process of transmitting a complement of user parameters to a device, according to an embodiment (500). It should be noted that the disclosed embodiments, such as the embodiments of FIG. 5 and FIG. 7, are intended to embrace numerous variations, including methods that may include actions in addition to those depicted in the figures, actions performed in an order different than those depicted in the figures, as well as methods including fewer steps than those depicted. The method of FIG. 5 begins at 505, which includes obtaining, via a communications network, one or more signals representing an indication of value encoded utilizing a machine-readable code available from a tangible object. 505 may involve a subscriber (such as subscriber 205 of FIG. 2) capturing an image of a machine-readable code to bring about initiation of an application for credit. In particular embodiments, a machine-readable code may correspond to a QR code, a one-dimensional or two-dimensional barcode, a machine-readable code emitted by a radiofrequency identification (RFID) device, a magnetic field-coupled inductive device, or any combination thereof.

The process may continue at 510, which may include obtaining, via a communications network, one or more signals representing an identifier of a communications device. An identifier of a communications device may correspond to a subscriber account identifier (e.g., a telephone number), an International Mobile Subscriber Identifier, an International Mobile Electronic Identifier, or a Mobile Station International Subscriber Directory Number, or any other unique identifier, or combinations thereof. At 510, an identifier of a communications device may be obtained, derived, or computed utilizing parameters stored in memory locations accessible to a processor of the communications device, such as memory locations of a SIM inserted into a receptacle. 510 may additionally include a communications device transmitting an identifier, such as accessed from a SIM of a communications device.

At 515, a client computing device, such as a server, under the direction or control of, for example, a gift card issuer (e.g., a merchant) may cooperate with an identity verifier to determine the identity of a subscriber, such as a subscriber co-located with a communications device. Responsive to a client (e.g., client 225 of FIG. 2) obtaining the name, address, and other parameters of subscriber 205, from an identity verifier (e.g., identity verifier 228 of FIG. 2), a client may transmit a request for one or more parameters unique to a subscriber co-located with a communications device (e.g., subscriber 205). Parameters unique to a subscriber co-located with a communications device may include the subscriber's date-of-birth, Social Security number, mother's maiden name, etc., and claimed subject matter is intended to embrace these parameters as well as any other parameters that may be known only or exclusively to a subscriber and/or close associates of a subscriber. 515 may also include, in response to receiving a response from subscriber 205 for one or more additional parameters, a client, such as client 225 of FIG. 2, may determine if a match exists between the one or more additional parameters and the name, address, and other parameters obtained from an identity verification service (e.g., identity verifier 228 of FIG. 2). 515 may include processing of signals indicative of the requested one or more parameters provided in response to the subscriber entering the one or more parameters into a graphical user interface of the communications device. For example, in particular embodiments, 515 may include the subscriber entering the last four digits of a Social Security number. The entered digits of a Social Security number (or other parameter) may be compared with corresponding parameters accessed from device database 230 to determine if a match exists between or among the corresponding parameters.

At 520, responsive to a match existing between the last four digits of a Social Security number (for example) provided by a subscriber and (again, for example) the last four digits of a Social Security number stored in a device database, a client may transmit, to the communications device, one or more signals to provide a complement of subscriber-specific parameters. A complement of subscriber-specific parameters may be utilized to pre-fill an application form, or other type of form, displayed on a display of a communications device located with subscriber 205.

In particular embodiments, in addition to a complement of subscriber-specific parameters being transmitted to a communications device for display and/or verification by the subscriber, a client may additionally apply a credit corresponding to an indication of value encoded via a machine-readable code available at the tangible object. Accordingly, responsive to a subscriber submitting a pre-filled application for credit with a merchant, a credit account may be established on behalf of the subscriber. Further, a credit may be applied to the credit account, which may permit the subscriber to redeem, for example, a gift card balance from the merchant.

In FIG. 6, computing device 602 may provide one or more sources of executable computer instructions in the form of physical states and/or signals (e.g., stored in memory states), for example. Computing device 602 may communicate with computing device 604 by way of a network connection, such as via network 608, for example. As previously mentioned, a connection, while physical, may be virtual while not necessarily being tangible. Although computing device 604 of FIG. 6 shows various tangible, physical components, claimed subject matter is not limited to a computing devices having only these tangible components as other implementations and/or embodiments may include alternative arrangements that may comprise additional tangible components or fewer tangible components, for example, that function differently while achieving similar results. Rather, examples are provided merely as illustrations. It is not intended that claimed subject matter be limited in scope to illustrative examples.

Memory 622 may comprise any non-transitory storage mechanism. Memory 622 may comprise, for example, primary memory 624 and secondary memory 626, additional memory circuits, mechanisms, or combinations thereof may be used. Memory 622 may comprise, for example, random access memory, read only memory, etc., such as in the form of one or more storage devices and/or systems, such as, for example, a disk drive including an optical disc drive, a tape drive, a solid-state memory drive, etc., just to name a few examples.

Memory 622 may comprise one or more articles utilized to store a program of executable computer instructions. For example, processor 620 may fetch executable instructions from memory and proceed to execute the fetched instructions. Memory 622 may also comprise a memory controller for accessing device readable-medium 640 that may carry and/or make accessible digital content, which may include code, and/or instructions, for example, executable by processor 620 and/or some other device, such as a controller, as one example, capable of executing computer instructions, for example. Under direction of processor 620, a non-transitory memory, such as memory cells storing physical states (e.g., memory states), comprising, for example, a program of executable computer instructions, may be executed by processor 620 and able to generate signals to be communicated via a network, for example, as previously described. Generated signals may also be stored in memory, also previously suggested.

Memory 622 may store electronic files and/or electronic documents, such as relating to one or more users, and may also comprise a machine-readable medium that may carry and/or make accessible content, including code and/or instructions, for example, executable by processor 620 and/or some other device, such as a controller, as one example, capable of executing computer instructions, for example. As previously mentioned, the term electronic file and/or the term electronic document are used throughout this document to refer to a set of stored memory states and/or a set of physical signals associated in a manner so as to thereby form an electronic file and/or an electronic document. That is, it is not meant to implicitly reference a particular syntax, format and/or approach used, for example, with respect to a set of associated memory states and/or a set of associated physical signals. It is further noted an association of memory states, for example, may be in a logical sense and not necessarily in a tangible, physical sense. Thus, although signal and/or state components of an electronic file and/or electronic document, are to be associated logically, storage thereof, for example, may reside in one or more different places in a tangible, physical memory, in an embodiment.

Algorithmic descriptions and/or symbolic representations are examples of techniques used by those of ordinary skill in the signal processing and/or related arts to convey the substance of their work to others skilled in the art. An algorithm is, in the context of the present patent application, and generally, is considered to be a self-consistent sequence of operations and/or similar signal processing leading to a desired result. In the context of the present patent application, operations and/or processing involve physical manipulation of physical quantities. Typically, although not necessarily, such quantities may take the form of electrical and/or magnetic signals and/or states capable of being stored, transferred, combined, compared, processed and/or otherwise manipulated, for example, as electronic signals and/or states making up components of various forms of digital content, such as signal measurements, text, images, video, audio, etc.

Processor 620 may comprise one or more circuits, such as digital circuits, to perform at least a portion of a computing procedure and/or process. By way of example, but not limitation, processor 620 may comprise one or more processors, such as controllers, micro-processors, micro-controllers, application specific integrated circuits, digital signal processors, programmable logic devices, field programmable gate arrays, the like, or any combination thereof. In various implementations and/or embodiments, processor 620 may perform signal processing, typically substantially in accordance with fetched executable computer instructions, such as to manipulate signals and/or states, to construct signals and/or states, etc., with signals and/or states generated in such a manner to be communicated and/or stored in memory, for example.

FIG. 6 also illustrates device 604 as including a component 632 operable with input/output devices, and communication bus 615, for example, so that signals and/or states may be appropriately communicated between devices, such as device 604 and an input device and/or device 604 and an output device. A user may make use of an input device, such as a computer mouse, stylus, track ball, keyboard, and/or any other similar device capable of receiving user actions and/or motions as input signals. Likewise, for a device having speech to text capability, a user may speak to generate input signals. Likewise, a user may make use of an output device, such as a display, a printer, etc., and/or any other device capable of providing signals and/or generating stimuli for a user, such as visual stimuli, audio stimuli and/or other similar stimuli.

FIG. 7 shows a flowchart for a process of transmitting a complement of user parameters to a communications device in response to determining parameter values encoded via a machine-readable code available on a tangible object, according to an embodiment 700. At 705, the process of FIG. 7 may begin in response to a subscriber (e.g., a customer or potential customer) obtaining an image, for example, of a QR code or other type of machine-readable code printed or inscribed on a surface of a gift card, or other type of tangible object. 710 may include determining whether a value indication encoded via the machine-readable code corresponds to a monetary value, for example, redeemable from a merchant (e.g., a gift card), or whether the value indication corresponds to a generic stored-value card redeemable at any establishment that accepts credit cards. Responsive to determining that the machine-readable code indicates that the tangible object corresponds to a generic stored-value card, 715 may be performed in which a communications device may apply the indication of value to an electronic wallet stored on a communications device.

Responsive to determining that the machine-readable code indicates that the tangible object corresponds to a gift card issued by a particular merchant, a server or other type of computing resource may communicate with a computing resource operating for example under the control of the particular merchant, such as at 720. 725 may include determining, such as by the client under the control of the merchant, whether the subscriber corresponds to a current account holder, or whether a new count is to be created on behalf of the subscriber. At 730, responsive to the subscriber corresponding to a current account holder, a value indicated via the machine-readable code may be applied as a credit to the account. At 735, responsive to a determination that the subscriber does not correspond to a current account holder, the client, operating under the control of the merchant, may obtain an indication of the trustworthiness of subscriber 205. 735 may involve the client cooperating with an identity verifier to ascertain whether particular deterministic events have occurred with respect to a communications device co-located with subscriber 205. Such deterministic events may correspond to whether subscriber 205 has recently ported a mobile telephone number or other type of identifier from a first communication services carrier to a second communication services carrier. A deterministic event may correspond to the tenure during which subscriber 205 has been associated with a particular communications device. A deterministic event may correspond to whether subscriber 205 has recently obtained a one-time-password for a communications device and/or whether subscriber 205 has recently reset a password for a communications device. A deterministic event may correspond to whether subscriber 205 has recently removed and/or replaced a SIM of a communications device. Additional deterministic events may be considered in computing a trust score for subscriber 205 and/or a communications device co-located with subscriber 205, and claimed subject matter is not limited in this respect.

In some embodiments, 740 may be performed in which a client may convey a prompt to a subscriber co-located with a communications device. A prompt may request that the subscriber enter a parameter known only or exclusively to the subscriber, such as the last four digits of a Social Security number, a date of birth of the subscriber, a mother's maiden name, or any other parameter that may be known only or exclusively to the subscriber. In some embodiments, a prompt to a subscriber co-located with a communications device may include a request for a biometric parameter, such as a fingerprint or thumbprint of the subscriber, an image of the subscriber's face, or any other biometric parameter, and claimed subject matter is not limited in this respect. 740 may also include receiving, from the subscriber, the additional parameter transmitted via the communications device.

At 745, in accordance with business rules and/or business logic set forth by a merchant operating or directing actions performed by a client computing device, a client computing device may determine whether subscriber 205, for example, has been assigned a relatively high trustworthiness score, a complement of subscriber-specific parameters may be transmitted or conveyed to a subscriber. At 750, responsive to receiving a complement of parameters which, at least in particular embodiments, populate or pre-fill a credit application, a subscriber may elect to submit a completed application at 765 which may result, such as at 775, with a merchant processing a completed application.

Returning now to 745, in accordance with business rules and/or business logic set forth by a merchant determining that subscriber 205 possesses a relatively low trustworthiness score, 760 may be performed, in which a client may determine that the subscriber is not eligible for account application pre-fill. At 765, the subscriber may manually complete a credit application. The application may be processed at 775.

In the context of the present patent application, the term “connection,” the term “component” and/or similar terms are intended to be physical, but are not necessarily always tangible. Whether or not these terms refer to tangible subject matter, thus, may vary in a particular context of usage. As an example, a tangible connection and/or tangible connection path may be made, such as by a tangible, electrical connection, such as an electrically conductive path comprising metal or other conductor, that is able to conduct electrical current between two tangible components. Likewise, a tangible connection path may be at least partially affected and/or controlled, such that, as is typical, a tangible connection path may be open or closed, at times resulting from influence of one or more externally derived signals, such as external currents and/or voltages, such as for an electrical switch. Non-limiting illustrations of an electrical switch include a transistor, a diode, etc. However, a “connection” and/or “component,” in a particular context of usage, likewise, although physical, can also be non-tangible, such as a connection between a client and a server over a network, particularly a wireless network, which generally refers to the ability for the client and server to transmit, receive, and/or exchange communications, as discussed in more detail later.

In a particular context of usage, such as a particular context in which tangible components are being discussed, therefore, the terms “coupled” and “connected” are used in a manner so that the terms are not synonymous. Similar terms may also be used in a manner in which a similar intention is exhibited. Thus, “connected” is used to indicate that two or more tangible components and/or the like, for example, are tangibly in direct physical contact. Thus, using the previous example, two tangible components that are electrically connected are physically connected via a tangible electrical connection, as previously discussed. However, “coupled,” is used to mean that potentially two or more tangible components are tangibly in direct physical contact. Nonetheless, “coupled” is also used to mean that two or more tangible components and/or the like are not necessarily tangibly in direct physical contact, but are able to co-operate, liaise, and/or interact, such as, for example, by being “optically coupled.” Likewise, the term “coupled” is also understood to mean indirectly connected. It is further noted, in the context of the present patent application, since memory, such as a memory component and/or memory states, is intended to be non-transitory, the term physical, at least if used in relation to memory necessarily implies that such memory components and/or memory states, continuing with the example, are tangible.

Additionally, in the present patent application, in a particular context of usage, such as a situation in which tangible components (and/or similarly, tangible materials) are being discussed, a distinction exists between being “on” and being “over.” As an example, deposition of a substance “on” a substrate refers to a deposition involving direct physical and tangible contact without an intermediary, such as an intermediary substance, between the substance deposited and the substrate in this latter example; nonetheless, deposition “over” a substrate, while understood to potentially include deposition “on” a substrate (since being “on” may also accurately be described as being “over”), is understood to include a situation in which one or more intermediaries, such as one or more intermediary substances, are present between the substance deposited and the substrate so that the substance deposited is not necessarily in direct physical and tangible contact with the substrate.

A similar distinction is made in an appropriate particular context of usage, such as in which tangible materials and/or tangible components are discussed, between being “beneath” and being “under.” While “beneath,” in such a particular context of usage, is intended to necessarily imply physical and tangible contact (similar to “on,” as just described), “under” potentially includes a situation in which there is direct physical and tangible contact, but does not necessarily imply direct physical and tangible contact, such as if one or more intermediaries, such as one or more intermediary substances, are present. Thus, “on” is understood to mean “immediately over” and “beneath” is understood to mean “immediately under”.

It is likewise appreciated that terms such as “over” and “under” are understood in a similar manner as the terms “up,” “down,” “top,” “bottom,” and so on, previously mentioned. These terms may be used to facilitate discussion, but are not intended to necessarily restrict scope of claimed subject matter. For example, the term “over,” as an example, is not meant to suggest that claim scope is limited to only situations in which an embodiment is right side up, such as in comparison with the embodiment being upside down, for example. An example includes a flip chip, as one illustration, in which, for example, orientation at various times (e.g., during fabrication) may not necessarily correspond to orientation of a final product. Thus, if an object, as an example, is within applicable claim scope in a particular orientation, such as upside down, as one example, likewise, it is intended that the latter also be interpreted to be included within applicable claim scope in another orientation, such as right side up, again, as an example, and vice-versa, even if applicable literal claim language has the potential to be interpreted otherwise. Of course, again, as always has been the case in the specification of a patent application, particular context of description and/or usage provides helpful guidance regarding reasonable inferences to be drawn.

Unless otherwise indicated, in the context of the present patent application, the term “or” if used to associate a list, such as A, B, or C, is intended to mean A, B, and C, here used in the inclusive sense, as well as A, B, or C, here used in the exclusive sense. With this understanding, “and” is used in the inclusive sense and intended to mean A, B, and C; whereas “and/or” can be used in an abundance of caution to make clear that all of the foregoing meanings are intended, although such usage is not required. In addition, the term “one or more” and/or similar terms is used to describe any feature, structure, characteristic, and/or the like in the singular, “and/or” is also used to describe a plurality and/or some other combination of features, structures, characteristics, and/or the like. Likewise, the term “based on” and/or similar terms are understood as not necessarily intending to convey an exhaustive list of factors, but to allow for existence of additional factors not necessarily expressly described.

Furthermore, it is intended, for a situation that relates to implementation of claimed subject matter and is subject to testing, measurement, and/or specification regarding degree, that the particular situation be understood in the following manner. As an example, in a given situation, assume a value of a physical property is to be measured. If alternatively reasonable approaches to testing, measurement, and/or specification regarding degree, at least with respect to the property, continuing with the example, is reasonably likely to occur to one of ordinary skill, at least for implementation purposes, claimed subject matter is intended to cover those alternatively reasonable approaches unless otherwise expressly indicated. As an example, if a plot of measurements over a region is produced and implementation of claimed subject matter refers to employing a measurement of slope over the region, but a variety of reasonable and alternative techniques to estimate the slope over that region exist, claimed subject matter is intended to cover those reasonable alternative techniques unless otherwise expressly indicated.

To the extent claimed subject matter is related to one or more particular measurements, such as with regard to physical manifestations capable of being measured physically, such as, without limit, temperature, pressure, voltage, current, electromagnetic radiation, etc., it is believed that claimed subject matter does not fall with the abstract idea judicial exception to statutory subject matter. Rather, it is asserted, that physical measurements are not mental steps and, likewise, are not abstract ideas.

It is noted, nonetheless, that a typical measurement model employed is that one or more measurements may respectively comprise a sum of at least two components. Thus, for a given measurement, for example, one component may comprise a deterministic component, which in an ideal sense, may comprise a physical value (e.g., sought via one or more measurements), often in the form of one or more signals, signal samples and/or states, and one component may comprise a random component, which may have a variety of sources that may be challenging to quantify. At times, for example, lack of measurement precision may affect a given measurement. Thus, for claimed subject matter, a statistical or stochastic model may be used in addition to a deterministic model as an approach to identification and/or prediction regarding one or more measurement values that may relate to claimed subject matter.

For example, a relatively large number of measurements may be collected to better estimate a deterministic component. Likewise, if measurements vary, which may typically occur, it may be that some portion of a variance may be explained as a deterministic component, while some portion of a variance may be explained as a random component. Typically, it is desirable to have stochastic variance associated with measurements be relatively small, if feasible. That is, typically, it may be preferable to be able to account for a reasonable portion of measurement variation in a deterministic manner, rather than a stochastic matter as an aid to identification and/or predictability.

Along these lines, a variety of techniques have come into use so that one or more measurements may be processed to better estimate an underlying deterministic component, as well as to estimate potentially random components. These techniques, of course, may vary with details surrounding a given situation. Typically, however, more complex problems may involve use of more complex techniques. In this regard, as alluded to above, one or more measurements of physical manifestations may be modeled deterministically and/or stochastically. Employing a model permits collected measurements to potentially be identified and/or processed, and/or potentially permits estimation and/or prediction of an underlying deterministic component, for example, with respect to later measurements to be taken. A given estimate may not be a perfect estimate; however, in general, it is expected that on average one or more estimates may better reflect an underlying deterministic component, for example, if random components that may be included in one or more obtained measurements, are considered. Practically speaking, of course, it is desirable to be able to generate, such as through estimation approaches, a physically meaningful model of processes affecting measurements to be taken.

In some situations, however, as indicated, potential influences may be complex. Therefore, seeking to understand appropriate factors to consider may be particularly challenging. In such situations, it is, therefore, not unusual to employ heuristics with respect to generating one or more estimates. Heuristics refers to use of experience related approaches that may reflect realized processes and/or realized results, such as with respect to use of historical measurements, for example. Heuristics, for example, may be employed in situations where more analytical approaches may be overly complex and/or nearly intractable. Thus, regarding claimed subject matter, an innovative feature may include, in an example embodiment, heuristics that may be employed, for example, to estimate and/or predict one or more measurements.

It is further noted that the terms “type” and/or “like,” if used, such as with a feature, structure, characteristic, and/or the like, using “optical” or “electrical” as simple examples, means at least partially of and/or relating to the feature, structure, characteristic, and/or the like in such a way that presence of minor variations, even variations that might otherwise not be considered fully consistent with the feature, structure, characteristic, and/or the like, do not in general prevent the feature, structure, characteristic, and/or the like from being of a “type” and/or being “like,” (such as being an “optical-type” or being “optical-like,” for example) if the minor variations are sufficiently minor so that the feature, structure, characteristic, and/or the like would still be considered to be substantially present with such variations also present. Thus, continuing with this example, the terms optical-type and/or optical-like properties are necessarily intended to include optical properties. Likewise, the terms electrical-type and/or electrical-like properties, as another example, are necessarily intended to include electrical properties. It should be noted that the specification of the present patent application merely provides one or more illustrative examples and claimed subject matter is intended to not be limited to one or more illustrative examples; however, again, as has always been the case with respect to the specification of a patent application, particular context of description and/or usage provides helpful guidance regarding reasonable inferences to be drawn.

With advances in technology, it has become more typical to employ distributed computing and/or communication approaches in which portions of a process, such as signal processing of signal samples, for example, may be allocated among various devices, including one or more client devices and/or one or more server devices, via a computing and/or communications network, for example. A network may comprise two or more devices, such as network devices and/or computing devices, and/or may couple devices, such as network devices and/or computing devices, so that signal communications, such as in the form of signal packets and/or signal frames (e.g., comprising one or more signal samples), for example, may be exchanged, such as between a server device and/or a client device, as well as other types of devices, including between wired and/or wireless devices coupled via a wired and/or wireless network, for example.

In the context of the present patent application, the term network device refers to any device capable of communicating via and/or as part of a network and may comprise a computing device. While network devices may be capable of communicating signals (e.g., signal packets and/or frames), such as via a wired and/or wireless network, they may also be capable of performing operations associated with a computing device, such as arithmetic and/or logic operations, processing and/or storing operations (e.g., storing signal samples), such as in memory as tangible, physical memory states, and/or may, for example, operate as a server device and/or a client device in various embodiments. Network devices capable of operating as a server device, a client device and/or otherwise, may include, as examples, dedicated rack-mounted servers, desktop computers, laptop computers, set top boxes, tablets, netbooks, smart phones, wearable devices, integrated devices combining two or more features of the foregoing devices, and/or the like, or any combination thereof. As mentioned, signal packets and/or frames, for example, may be exchanged, such as between a server device and/or a client device, as well as other types of devices, including between wired and/or wireless devices coupled via a wired and/or wireless network, for example, or any combination thereof. It is noted that the terms, server, server device, server computing device, server computing platform and/or similar terms are used interchangeably. Similarly, the terms client, client device, client computing device, client computing platform and/or similar terms are also used interchangeably. While in some instances, for ease of description, these terms may be used in the singular, such as by referring to a “client device” or a “server device,” the description is intended to encompass one or more client devices and/or one or more server devices, as appropriate. Along similar lines, references to a “database” are understood to mean, one or more databases and/or portions thereof, as appropriate.

It should be understood that for ease of description, a network device (also referred to as a networking device) may be embodied and/or described in terms of a computing device and vice-versa. However, it should further be understood that this description should in no way be construed so that claimed subject matter is limited to one embodiment, such as only a computing device and/or only a network device, but, instead, may be embodied as a variety of devices or combinations thereof, including, for example, one or more illustrative examples.

In the context of the present patent application, the term sub-network and/or similar terms, if used, for example, with respect to a network, refers to the network and/or a part thereof. Sub-networks may also comprise links, such as physical links, connecting and/or coupling nodes, so as to be capable to communicate signal packets and/or frames between devices of particular nodes, including via wired links, wireless links, or combinations thereof. Various types of devices, such as network devices and/or computing devices, may be made available so that device interoperability is enabled and/or, in at least some instances, may be transparent. In the context of the present patent application, the term “transparent,” if used with respect to devices of a network, refers to devices communicating via the network in which the devices are able to communicate via one or more intermediate devices, such as one or more intermediate nodes, but without the communicating devices necessarily specifying the one or more intermediate nodes and/or the one or more intermediate devices of the one or more intermediate nodes and/or, thus, may include within the network the devices communicating via the one or more intermediate nodes and/or the one or more intermediate devices of the one or more intermediate nodes, but may engage in signal communications as if such intermediate nodes and/or intermediate devices are not necessarily involved. For example, a router may provide a link and/or connection between otherwise separate and/or independent LANs.

The term electronic file and/or the term electronic document are used throughout this document to refer to a set of stored memory states and/or a set of physical signals associated in a manner so as to thereby, at least logically, form a file (e.g., electronic) and/or an electronic document. That is, it is not meant to implicitly reference a particular syntax, format and/or approach used, for example, with respect to a set of associated memory states and/or a set of associated physical signals. If a particular type of file storage format and/or syntax, for example, is intended, it is referenced expressly. It is further noted an association of memory states, for example, may be in a logical sense and not necessarily in a tangible, physical sense. Thus, although signal and/or state components of a file and/or an electronic document, for example, are to be associated logically, storage thereof, for example, may reside in one or more different places in a tangible, physical memory, in an embodiment.

Also, for one or more embodiments, an electronic document and/or electronic file may comprise a number of components. As previously indicated, in the context of the present patent application, a component is physical, but is not necessarily tangible. As an example, components with reference to an electronic document and/or electronic file, in one or more embodiments, may comprise text, for example, in the form of physical signals and/or physical states (e.g., capable of being physically displayed). Typically, memory states, for example, comprise tangible components, whereas physical signals are not necessarily tangible, although signals may become (e.g., be made) tangible, such as if appearing on a tangible display, for example, as is not uncommon. Also, for one or more embodiments, components with reference to an electronic document and/or electronic file may comprise a graphical object, such as, for example, an image, such as a digital image, and/or sub-objects, including attributes thereof, which, again, comprise physical signals and/or physical states (e.g., capable of being tangibly displayed). In an embodiment, digital content may comprise, for example, text, images, audio, video, and/or other types of electronic documents and/or electronic files, including portions thereof, for example.

For one or more embodiments, a device, such as a computing device and/or networking device, may comprise, for example, any of a wide range of digital electronic devices, including, but not limited to, desktop and/or notebook computers, high-definition televisions, digital versatile disc (DVD) and/or other optical disc players and/or recorders, game consoles, satellite television receivers, cellular telephones, tablet devices, wearable devices, personal digital assistants, mobile audio and/or video playback and/or recording devices, Internet of Things (IoT) type devices, or any combination of the foregoing. Further, unless specifically stated otherwise, a process as described, such as with reference to flow diagrams and/or otherwise, may also be executed and/or affected, in whole or in part, by a computing device and/or a network device. A device, such as a computing device and/or network device, may vary in terms of capabilities and/or features. Claimed subject matter is intended to cover a wide range of potential variations. For example, a device may include a numeric keypad and/or other display of limited functionality, such as a monochrome liquid crystal display (LCD) for displaying text, for example. In contrast, however, as another example, a web-enabled device may include a physical and/or a virtual keyboard, mass storage, one or more accelerometers, one or more gyroscopes, global positioning system (GPS) and/or other location-identifying type capability, and/or a display with a higher degree of functionality, such as a touch-sensitive color 2D or 3D display, for example.

As suggested previously, communications between a computing device and/or a network device and a wireless network may be in accordance with known and/or to be developed network protocols including, for example, global system for mobile communications (GSM), enhanced data rate for GSM evolution (EDGE), 802.11b/g/n/h, etc., and/or worldwide interoperability for microwave access (WiMAX). As suggested previously, a computing device and/or a networking device may also have a SIM, which, for example, may comprise a detachable or embedded smart card that is able to store subscription content of a user, and/or is also able to store a contact list. It is noted, as previously mentioned, that a SIM may also be electronic in the sense that it may simply be sorted in a particular location in memory of the computing and/or networking device. A user may own the computing device and/or network device or may otherwise be a user, such as a primary user, for example. A device may be assigned an address by a wireless network operator, a wired network operator, and/or an Internet Service Provider (ISP). For example, an address may comprise a domestic or international telephone number, an Internet Protocol (IP) address, and/or one or more other identifiers. In other embodiments, a computing and/or communications network may be embodied as a wired network, wireless network, or any combinations thereof.

A computing and/or network device may include and/or may execute a variety of now known and/or to be developed operating systems, derivatives and/or versions thereof, including computer operating systems, such as Windows, iOS, Linux, a mobile operating system, such as iOS, Android, Windows Mobile, and/or the like. A computing device and/or network device may include and/or may execute a variety of possible applications, such as a client software application enabling communication with other devices. For example, one or more messages (e.g., content) may be communicated, such as via one or more protocols, now known and/or later to be developed, suitable for communication of email, short message service (SMS), and/or multimedia message service (MMS), including via a network, such as a social network, formed at least in part by a portion of a computing and/or communications network. A computing and/or network device may also include executable computer instructions to process and/or communicate digital content, such as, for example, textual content, digital multimedia content, and/or the like. A computing and/or network device may also include executable computer instructions to perform a variety of possible tasks, such as browsing, searching, playing various forms of digital content, including locally stored and/or streamed video, and/or games such as, but not limited to, fantasy sports leagues. The foregoing is provided merely to illustrate that claimed subject matter is intended to include a wide range of possible features and/or capabilities.

In the preceding description, various aspects of claimed subject matter have been described. For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter.

What is claimed is:

1. A method comprising:
obtaining, via a communications network, one or more signals representing an indication of value encoded utilizing a machine-readable code available at a tangible object, the one or more signals representing the indication of value to be provided by a communications device;
obtaining via the communications network one or more signals representing an identifier of the communications device;
authenticating the communications device based, at least in part, on the one or more signals representing the identifier; and
transmitting, via the communications network, one or more signals to represent a complement of subscriber-specific parameters responsive to the authenticating.

2. The method of claim 1, wherein the machine-readable code comprises one or more quick response (QR) codes.

3. The method of claim 1, wherein the machine-readable code comprises one or more characters that are human-readable.

4. The method of claim 1, wherein the complement of subscriber-specific parameters correspond to parameters for completing an electronic document to obtain an account with a merchant.

5. The method of claim 4, wherein the machine-readable code is encoded on a viewable surface of a gift card and comprises one or more unique number combinations and/or an identifier exclusive to the gift card, a remaining balance of the gift card, and/or an indicator as to whether the gift card has been activated.

6. The method of claim 1, wherein authenticating the communications device comprises receiving, via the communications network, one or more parameters accessed from a subscriber information module (SIM) of the communications device.

7. The method of claim 1, wherein the communications network comprises a mobile cellular communications network.

8. The method of claim 1, further comprising:
receiving one or more parameters entered utilizing a user interface of the communications device responsive to a prompt displayed via the user interface of the communications device.

9. The method of claim 8, wherein the one or more parameters entered utilizing the user interface of the communications device correspond to at least a portion of a unique identifier corresponding to an owner of the communications device, at least a portion of a physical address corresponding to the owner of the communications device, a parameter known exclusively to the owner of the communications device, a biometric parameter of the owner of the communications device, or any combination thereof.

10. The method of claim 1, wherein authenticating the communications device includes determining a number of porting requests have been received over a duration with respect to the communications device, a tenure of the communications device, whether a subscriber identity module (SIM) of the communications device has been removed and/or replaced over the duration, whether a one-time password of a communications device subscriber account has been requested, or any combination thereof.

11. An apparatus comprising:
a processor coupled to at least one memory device to:
obtain, from a network coupled to a communications device, one or more signals representing an indication of value encoded utilizing a machine-readable code at a tangible object, the one or more signals representing the indication of value to be provided by the communications device;
obtain, from the network, one or more signals representing an identifier of the communications device;
authenticate the communications device based, at least in part, on the one or more signals representing the identifier; and
transmit, via the network, one or more signals to represent a complement of subscriber-specific parameters in response to the authenticating.

12. The apparatus of claim 11, wherein to authenticate the communications device is to determine a number of porting requests have been received over a duration with respect to the communications device, to determine a tenure of the communications device, to determine whether a subscriber identity module (SIM) of the communications device has been removed and/or replaced over the duration, to determine whether a one-time password of a communications device subscriber account has been requested, or to determine any combination thereof.

13. The apparatus of claim 11, wherein the processor coupled to the at least one memory device are further to:
receive one or more parameters entered utilizing a user interface of the communications device responsive to a prompt displayed via the user interface of the communications device.

14. The apparatus of claim 13, wherein the one or more parameters entered utilizing the user interface of the communications device correspond to at least a portion of a unique identifier corresponding to an owner of the communications device, at least a portion of a physical address corresponding to the owner of the communications device, a parameter known exclusively to the owner of the communications device, a biometric parameter of the owner of the communications device, or any combination thereof.

15. The apparatus of claim 11, wherein the tangible object includes a gift card and wherein the machine-readable code includes a quick response (QR) code.

16. The apparatus of claim 11, wherein the processor coupled to the at least one memory device to authenticate the communications device is additionally to receive, via the network, one or more parameters accessed from a subscriber information module (SIM) of the communications device.

17. An article comprising:
a non-transitory storage medium having instructions stored thereon executable by a special-purpose computing platform to:
obtain, from a network coupled to a communications device, one or more signals representing an indication of value encoded utilizing a machine-readable code at a tangible object, the one or more signals representing the indication of value to be provided by the communications device;
obtain, from the network, one or more signals representing an identifier of the communications device;
authenticate the communications device based, at least in part, on the one or more signals representing the identifier; and
transmit, via the network, one or more signals to represent a complement of subscriber-specific parameters in response to the authenticating.

18. The article of claim 17, wherein the tangible object includes a gift card, and wherein the machine-readable code includes a quick response (QR) code.

19. The article of claim 17, wherein the identifier of the communications device is to be obtained from a subscriber identity module (SIM) of the communications device.

20. The article of claim 17, wherein to authenticate the communications device is to determine a number of porting requests have been received over a duration with respect to the communications device, to determine a tenure of the communications device, to determine whether a subscriber identity module (SIM) of the communications device has been removed and/or replaced over the duration, to determine whether a one-time password of a communications device subscriber account has been requested, or to determine any combination thereof.
